(19) United States
(12) Patent Application Publication
(10) Pub. No.: US 2002/0185781 A1
(43) Pub. Date: Dec. 12, 2002

(54) Diagonal candle

(76) Inventor: Jose Santis, Scottsdale, AZ (US)

Correspondence Address: Damon L. Boyd, Snell & Wilmer L.L.P., One Arizona Center, 400 East Van Buren, Phoenix, AZ, 85004-2202, US

(21) Appl. No.: 10/123,954

(22) Filed: Apr. 16, 2002

Related U.S. Application Data
(60) Provisional application No. 60/284,111, filed on Apr. 16, 2001.

(51) Int. Cl. B29C 39/02

(52) U.S. Cl. 264/330; 425/803; 425/463

(57) ABSTRACT

Methods and apparatus for manufacturing a sectioned candle is provided. For example, in accordance with various embodiments of the present invention, a candle mold is provided which, through various structures, may be oriented at various angles. Thus, by orienting the mold at different angles, improved control of the angle of a sectional divide of various sections of the candle is obtained. Additionally, by controlling the temperatures of the materials for making the candles during processing, the quality of the candle, such as for example, the bonding between the sections of the candle can be improved.

### BACKGROUND OF THE INVENTION

1. Technical Field

This invention relates generally to candles, and more particularly, to candles with multiple sections divided diagonally.

2. Background Information

Candles are manufactured in all shapes and sizes. The most common candles have standard shapes and sizes such as round, triangular, or square. Similarly, many processes are known for making ordinary candles. Generally, these processes include filling a mold with molten wax, allowing the wax to harden, and inserting a wick.

However, as the wax hardens, the wax also begins to contract (as most substances do when they cool). This contraction generally causes the top of the candle to collapse, leaving a depression proximate to the top and center of the candle. As candles with these depressions are generally not aesthetically pleasing, before the candle completely hardens, a core of the candle is removed (e.g., by drilling) and additional molten wax is poured into the core. Because the wax is poured in at least two steps, it is important to ensure that the later pours are done before the first pour of wax candle completely hardens so that when the later pours are made, the freshly poured wax bonds to the later poured wax. Thus, this method of making candles can be somewhat complex.

Additionally, the foregoing method for manufacturing candles does not allow for multiple pours of different colored wax which create a diagonal division between the different colors. Likewise, the foregoing method is not conducive to the manufacture of large numbers of candles which have consistently uniform diagonal divisions. Accordingly, methods and apparatus for making a multiple section candle where the sections are divided diagonally are desirable.

### BRIEF SUMMARY OF THE INVENTION

Methods and apparatus for manufacturing a sectioned candle is provided. For example, in accordance with various embodiments of the present invention, a candle mold is provided which, through various structures, may be oriented at various angles. Thus, by orienting the mold at different angles, improved control of the angle of a sectional divide of various sections of the candle is obtained. Additionally, by controlling the temperatures of the materials for making the candles during processing, the quality of the candle, such as for example, the bonding between the sections of the candle can be improved.

### BRIEF DESCRIPTION OF THE SEVERAL VIEWS OF THE DRAWINGS

Additional aspects of the present invention should become evident upon reviewing the non-limiting embodiments described in the specification taken in conjunction with the accompanying figures, wherein like numerals designated like elements, and:

FIG. 1 is a block diagram of a process for making a diagonal candle in accordance with the present invention;

FIG. 2 is a block diagram of a process for making multiple section diagonal candles in accordance with an alternative aspect of the present invention;

FIG. 3 is a cross sectional side view of a first pour of a candle in accordance with the present invention;

FIG. 4 is a cross sectional side view of a second pour of a candle in accordance with the present invention;

FIG. 5 is a candle after removal from a mold in accordance with the present invention; and

FIG. 6 is a filter unit and mold table in accordance with the present invention.

### DETAILED DESCRIPTION OF PREFERRED EXEMPLARY EMBODIMENTS

The following descriptions are exemplary embodiments of the invention only, and are not intended to limit the scope, applicability or configuration of the invention in anyway. Rather, the following description is intended to provide convenient illustrations for implementing various embodiments of the invention. Thus, as will become apparent, various changes may be made in the function and arrangement of the elements described herein without departing from the spirit and scope of the invention. For example, as described in further detail herein, candles in accordance with the present invention have two distinct sections of wax, where the distinction between the sections is oriented at 45° angle from horizontal. Although a 45° angle is referred to most commonly herein, it should be appreciated that the angle is merely illustrative and any other angle may be substituted.

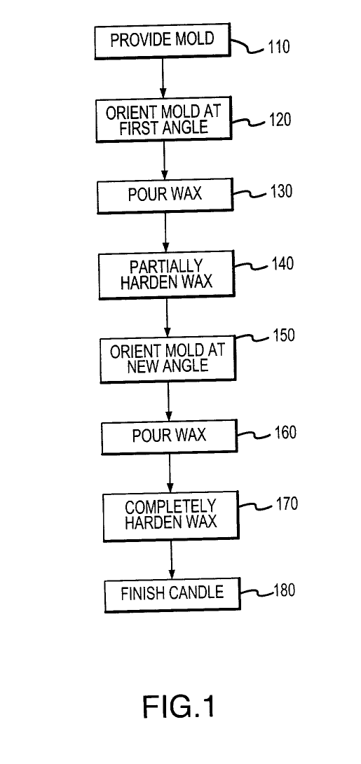

That being said, in general, a method in accordance with the present invention for manufacturing a candle having multiple sections, where the sections are divided diagonally is provided. For example, with reference to FIG. 1, in one exemplary embodiment of the present invention, a method comprises the steps of providing a mold for a candle 110 and orientating the mold at a first angle 120. This first angle thus defines the angle of the diagonal division between two adjacent sections of wax. In the presently described embodiment, the first angle is about 45°. After the mold is oriented at the first angle 120, molten wax is poured into the angled mold 130 and the wax is allowed to partially harden 140. This forms a lower diagonal section of the candle. After the wax has partially hardened 140, the mold is oriented at a new angle 150 and a second pour of wax 160 over the first pour 130 is made to form the upper diagonal section of the candle. The wax is then allowed to completely harden 170. Finally, any necessary finishing steps 180 are performed. Thus, through the use of this process, a candle is formed which has substantially distinct bottom and top sections wherein the contact between those two sections has a diagonal appearance.

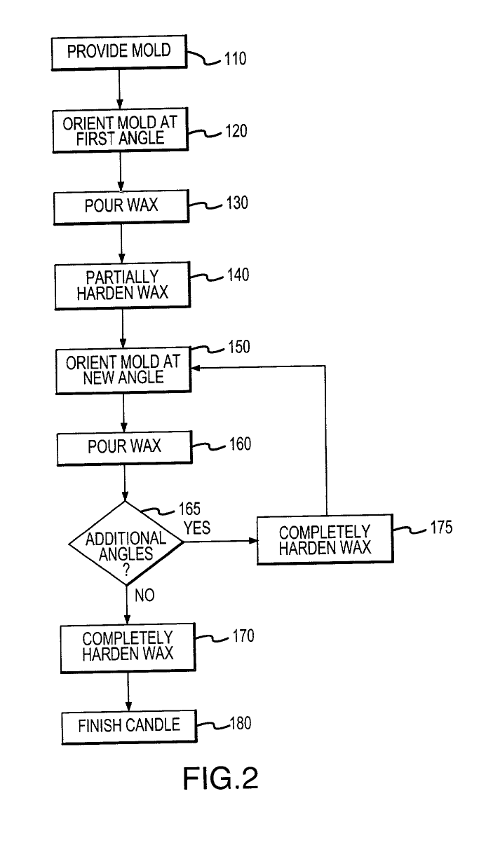

Additionally, many of these processing steps may be interchanged. For example, depending on the particular application of the present invention, the various finishing steps 180 (e.g., wick insertion) may be performed prior to complete hardening 170 of the candle. Likewise, in accordance with various alternative aspects of the present invention, the process can be modified to form candles having more than two distinct sections. For example, with reference now to FIG. 2, after first creating the lower diagonal section of the candle and after the second pour of molten wax into the mold 160, a determination of whether additional diagonal sections are desired 165. If no additional sections are desired, the process is generally completed as described above. If an additional section is desired, the preceding pour of wax is allowed to partially harden 175 and a new angle is chosen for still another pour, producing a candle with three distinct sections. Again, any angle, including horizontal may be chosen. Moreover, it should be apparent that the same process may be repeated numerous times depending on the desired number of sections.

In accordance with various embodiments of the present invention, it is likely desirable for each section to have a different characteristic the sections immediately adjacent to it. For example, the color, texture, scent (or any other characteristic) is typically varied. Likewise, the different sections may have different properties and function, such as translucency, fragrance or the like.

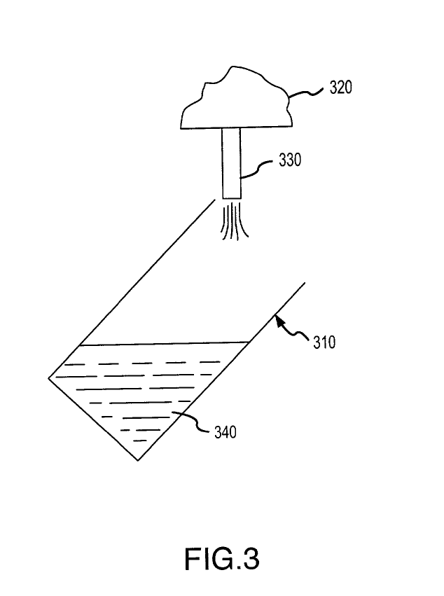

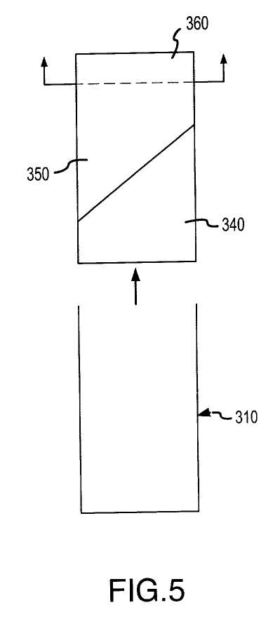

With reference now to FIGS. 3-5, a description of the process in accordance with an exemplary embodiment of the present invention follows. First, with reference to FIG. 3, a mold 310 and a filler unit 320 are shown. In this embodiment, filler 320 comprises a multi-head programmable controller hot wax filler used for filling candle molds. Of course, it should be apparent that any other filling units now known in the industry or as yet to be devised may likewise be used with the methods and apparatus of the present invention, but generally, filler 320 is any device (or person) which pours molten wax into mold 310. In the presently described embodiment, filler 320 has 13 linearly arranged pour nozzles 330 capable of filling 13 linearly arranged molds 310. As will be described in additional detail herein, alternating rows of 13 or 12 molds are filled during processes in accordance with the present invention.

With continuing reference to FIG. 3, in the present embodiment, mold 310 comprises a cylindrical cavity of the same shape as the ultimately desired finished candle. Of course the shape of mold 310 may vary depending on the shape of candle desired. One end of mold 310 is open for receiving the molten wax. The opposing end is closed. In the presently described embodiment, mold 310 has a diameter of 3 inches and a height of 6 inches, with a resulting volume of about 10 oz. In accordance with the present invention, mold 310 is oriented at a 45° angle underneath filler nozzle 320 and a first pour of wax is inserted into mold 310 to make a lower wax section 340 of candle. The 45° angle of mold 310 is suitably accomplished by any means which allows mold 310 to pivot. For example, in the present exemplary embodiment, mold 310 is placed in a rack which is hingedly connected to the mold table such that the rack can pivot up against a stop which prevents the rack from rotating beyond the desired 45° angle. Of course, other means are likewise suitable for maintaining mold 310 at a desired angle. For example, other embodiments may include various configurations of the rack, mold 310 itself may be hingedly connected to table, and various locking and stop mechanisms may be provided to maintain mold 310 at an angle.

Generally, lower wax section 340 comprises any wax such as a paraffin or natural wax and likewise may be of any color or contain various additives such as fragrance or other volatile material to be distributed when the candle is burned. In the presently described embodiment, lower wax section 340 comprises a paraffin wax available from International Group, Inc. of Houston, Tex. under the designation IGI#1071 (“IGI#1071”). Lower wax section 340 is poured at a temperature such that lower wax section 340 is molten, and preferably, so that lower wax section 340 can be cooled to a temperature which allows wax poured later to sufficiently bond with lower wax section 340. For example, lower wax section is poured at a temperature of over about 185 degrees Fahrenheit and preferably between or about 190 to 195 degrees Fahrenheit, though other temperatures, depending on the type of wax used and/or other conditions may be used.

As mentioned above, lower wax section 340 is allowed to cool to a temperature which allows bonding with wax poured after lower wax section 340. For example, lower wax section 340 is cooled to less than about 140 degrees Fahrenheit, and preferably to about 120 to 130 degrees Fahrenheit. In the present exemplary embodiment, this partial hardening equates to allowing the wax to cool for about 100 minutes at an ambient room temperature of 73 degrees Fahrenheit. In accordance with various aspects of the present invention, it may be important to ensure that the lower section of wax does not become too hard. If the lower section becomes too hard, when adjacent pours of wax are made, there is a lower likelihood of chemical and/or physical bonding between the sections of the candle.

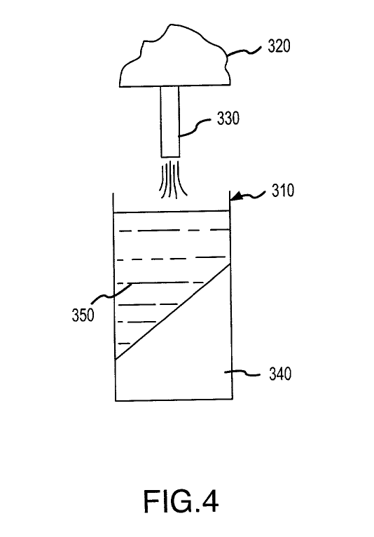

As mentioned above, after the appropriate amount of hardening, mold 310 is oriented at a new angle for filling with an upper wax section 350. For example, with reference to FIG. 4, mold 310 is oriented in a vertical position. After orienting mold 310 at its new angle, an upper wax section 350 is poured into mold 310. In the present embodiment, upper wax section 350 comprises IGI#1071, but again, as mentioned above, any other type of wax depending on the particular properties desired, may likewise be substituted. Further, upper wax section 350 is poured at a temperature of about 194 to 196 degrees Fahrenheit, though again, other temperatures may be used depending on various factors such as the ambient temperature and type of wax. Further still, upper wax section 350 will typically be of a different color than lower wax section 340 so that the diagonal distinction formed between lower wax section 340 and upper wax section 350 is readily apparent. Upper wax section 350 is then allowed to completely harden and the candle is removed from mold 310.

After removal from mold 310, the diagonal candle can then be put through various finishing steps. For example, as mentioned in the Background of the Invention section above, when wax cools, it typically contracts leaving a depression on the surface of the candle. In the present embodiment, an upper portion 360 of the candle having the depression is cut away leaving a flat surface. By cutting away top portion 360, any need to drill and/or fill the depression for aesthetic reasons is eliminated. After the candle is finished to the appropriate size, a wick is inserted into candle through various means, such as, for example, drilling a hole through candle and inserting a standard wick. Of course it should be apparent that the wick need not be inserted after finishing of the candle, but may rather placed in the mold during the fill process. Likewise, the standard drill insertion method does not have to be used, but rather other methods of inserting wicks into finished candles may likewise be employed.

Processes in accordance with the present invention, thus increase the efficiency, uniformity and appearance of diagonal candles. For example, as mentioned above, depressions resulting from the contracting wax on the surface of the candle do not require multiple drilling and wax pouring steps. In the illustrated embodiment, after pouring lower wax section 340, the depression is formed on the diagonal surface of lower wax section 340 within candle. There is no need to drill out the core of the depression since the next pour will fill the depression. Stated otherwise, because the depression occurs centrally to the candle, after pouring upper wax section 350, the depression is covered and cannot be seen. Similarly, as mentioned above, after the upper wax section 350 is poured, the section of the candle containing the depression on top of the candle is cut away. Again, there is no need for drilling the core or another pour of wax.

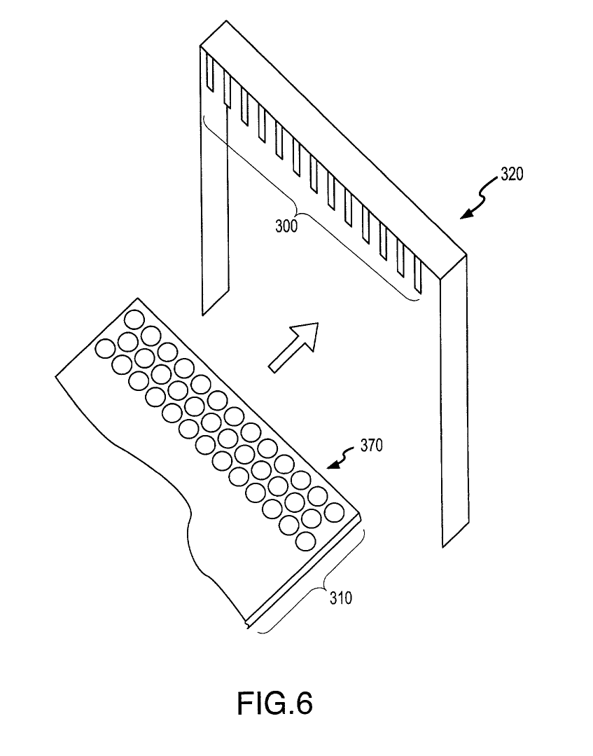

Processes in accordance with the present invention also increase the throughput of candles during manufacturing. For example, with reference to FIG. 6, as mentioned above, filler unit 320 has 13 filler nozzles 330. Typically, filler nozzles 330 are mounted linearly such that a table 370 which carries molds 310 may be passed underneath nozzles 330. Molds 310 are organized with alternating roles of 13 and 12 molds. For example, FIG. 6 shows a first row of 13 molds 310, a second row of 12 molds 310, a third row 13 molds 310 and so forth. The nesting of 12 and 13 cylindrical molds per row thus allows an increased number of molds 310 to be placed on table 370 and requires less overall space.

Additionally, filler unit 330 is preferably configured with a sensing device such as a photoelectric eye capable of determining the number of molds in the row presently being filled. Thus, for the first 13 mold row, filler unit 330 would direct all 13 filler nozzles 330 to be positioned over molds 310 and all 13 filler nozzles 330 operate. As table 370 moves under filler unit 320 to the next row, the sensing device detects that the current row contains only 12 molds and thus directs one filler nozzle 330 at the end of filler unit 320 to not fill during the filling of this row. Additionally, filler unit 320 would direct the filler nozzles 330 to shift so that the filler nozzles 330 are positioned over each of the 12 molds 310, with one nozzle 330 not being located over any mold 310.

Lastly, as initially mentioned herein, various aspects of the invention have been described above. It should be apparent, that many combinations and modifications of the above described structure, arrangements, proportions, elements, materials and components used to practice the invention, in addition to those not specifically described may be varied and particularly adapted to various environments and operating requirements without departing from the spirit and scope of the invention.

1. A method for forming a sectioned candle, comprising the steps of:
providing a mold;
orienting said mold at a first angle, said first angle defining a diagonal angle between sections of the sectioned candle;
filling said mold with a first predetermined amount of a first wax;
changing a temperature of said first wax to a predetermined temperature;
orienting said mold at a second angle;
filling said mold with a second predetermined amount of a second wax; and
hardening said first and second waxes.

2. A method in accordance with claim 1, further comprising the step of removing said first and second waxes from said mold.

3. A method in accordance with claim 2, further comprising the step of removing an upper portion of said second wax to provide a surface substantially perpendicular to a side of the sectioned candle.

4. A method in accordance with claim 1, further comprising the step of inserting a wick into said first and second waxes after said hardening step.

5. A method in accordance with claim 1, further comprising the step of inserting a wick into said mold before filling said mold with said first and second waxes.

6. A method in accordance with claim 1, wherein said predetermined temperature is selected such that said first and second waxes bond together at a contact point between said first and second waxes when hardened.

7. A method in accordance with claim 1, wherein said temperature of said first wax is greater than about 185 degrees Fahrenheit during said first filling step.

8. A method in accordance with claim 7, wherein said temperature of said first wax is about 190 to about 195 degrees Fahrenheit during said first wax filling step.

9. A method in accordance with claim 1, wherein said first wax is changed to a temperature of less than about 140 degrees Fahrenheit after said first wax cooling step.

10. A method in accordance with claim 9, wherein said first wax is changed to a temperature of about 120 to about 130 degrees Fahrenheit.

11. A method in accordance with claim 1, wherein said temperature of said second wax is above about 190 degrees Fahrenheit during said second wax filling step.

12. A method in accordance with claim 11, wherein said temperature of said second wax is about 194 to about 196 degrees Fahrenheit during said second wax filling step.

13. A method in accordance with claim 1, wherein said first wax is cooled for about 90 to about 110 minutes at an ambient room temperature during said first wax cooling step.

14. A method in accordance with claim 13, wherein said first wax is cooled for about 100 minutes.

15. A method in accordance with claim 1, wherein said mold is filled with said second wax when said first wax has a temperature of about 120 to about 130 degrees Fahrenheit.

16. A method in accordance with claim 1, wherein said first angle is about 45 degrees and said second angle is about 90 degrees.

17. An apparatus for manufacturing a sectioned candle, comprising a candle mold connected to a mold orientating structure, said mold orientating structure having a first position defining a first angle and a second position defining a second angle.

18. An apparatus in accordance with claim 17, wherein said candle mold is connected to said mold orientating structure by placement in an aperture in said mold orientating structure.

19. An apparatus in accordance with claim 18, wherein said mold orientating structure has a plurality of apertures arranged in rows.

20. An apparatus in accordance with claim 19, wherein said rows have alternating numbers of apertures.

21. An apparatus in accordance with claim 18, wherein said mold orientating structure rotates from said first position to said second position.

22. An apparatus in accordance with claim 17, wherein said first angle is about 45 degrees.

23. An apparatus in accordance with claim 17, wherein said second angle is about 90 degrees.

24. An apparatus in accordance with claim 17, further comprising a filling unit.

25. An apparatus in accordance with claim 20, wherein said mold orienting structure has rolling members, and further comprises a filling unit configured such that said mold orientating structure rolls on said rolling members under said filler unit.
